(19) United States
(12) Patent Application Publication
(10) Pub. No.: US 2011/0219915 A1
(43) Pub. Date: Sep. 15, 2011

(54) Nail Driver

(76) Inventor: Freeman Douglas Mingo, Medicine Hat (CA)

(21) Appl. No.: 12/661,249

(22) Filed: Mar. 12, 2010

(51) Int. Cl. B25C 3/00

(52) U.S. Cl. 81/44

(57) ABSTRACT

A nail driver that is a non separable bottom loader. The driver is equipped with handles with the striking area penetrating through the handle enabling the user to strike the striking area only reduce the vibration received when using it manually or with a hammer. A handle on the rod allows it to be held safely while striking the striking area on top of the rod handle with a hammer. The tool is small enough to be easily stored in a workers tool box. A plurality of sizes permit the user to hold a wide variety of nail sizes required.

### FIELD OF THE INVENTION

The present invention relates to a nail driver and, more particularly, to a nail driver that will hold and allow for the insertion of nails into materials under difficult to access circumstances such as tight hard to access spaces.

### BACKGROUND OF THE INVENTION

Carpenters often are required to place nails into materials that are located in hard to access locations. This may be a tight corner, between a counter and a wall, in a narrow spot between rafters or other difficult to access locations. Even though a hammer or nail gun may not fit into that location it is still a requirement that an appropriate fastener be inserted to secure the materials. The carpenter must either fudge and not do the job correctly, try to get a nail into that location and be satisfied with a poorly placed or penetrated nail or devise some Jerry rigged device to try and get the nail into the location in a meaningful manner.

Hammers and nail guns are the principal solutions that exist in prior art. U.S. Pat. No. 6,968,989 offers a hand pounded nail driver. U.S. Pat. No. 6,708,585 also offers a hand pounded nail driver: U.S. Pat. No. 5,605,271 uses a coil spring; U.S. Pat. No. 5,559,234 requires the use of a hammer: U.S. Pat. No. 4,600,135 does so by using air; U.S. Pat. No. 4,139,136 is a multi nail holder: U.S. Pat. No. 4,029,135 requires a hammer; U.S. Pat. No. 4,367,836 is an automatic driver; U.S. Pat. No. 3,979,040 uses magnets lacking a guide as you pull back on the driving rod; U.S. Pat. No. 5,181,644 requires a hammer to operate. And U.S. Pat. No. 6,286,742 requires air to operate. U.S. Pat. No. 4,367,836 is complicated in design and requires bearings to facilitate the ram portion and is limited to types and sizes of nails. U.S. Pat. No. 4,139,136 is equipped with magazines defeating the purpose of the present invention by making it too large to be placed and operated in tight working conditions.

The solutions described in other solutions only partially meet the needs of the carpenter who has a need to do the job properly and efficiently. Other prior art solutions require the use of air or are very bulky restricting them to use in only more open areas thus limiting their applications in the more difficult to access locations between tight spots, through small openings or other difficult to reach or work in locations. Some require the use of a hammer, which in many restricted locations is not possible to swing or to swing with enough force to insert the nail or without the hammer hitting surrounding materials creating damage that could be structural or cosmetic in nature. Still others only permit the use of a hand driver making it slow and tedious where large numbers of larger nails can be driver with the aid of a hammer. These issues can result in less than satisfactory work, less than secure structures or structures failing as time passes and loads are placed on the construction being performed. The overall problem results in work improperly performed because of the impossibility of access or because of the difficulty of access and since these locations are often in semi hidden locations quality control inspections may miss the problem resulting in safety or financial critical loss.

### SUMMARY OF THE INVENTION

In accordance with the present invention, there is provided a nail driver that is a non separable bottom loader. The driver is equipped with a handle in which the nail driving rod passes through to the top of the handle. It may be driven with a hammer or manually with the driving handle. A second handle on the barrel allows the nail driver to be held in place and strike the nail that is loaded by gripping the handle on the driving rod and hitting the nail in place. A handle on the barrel allows the tool to be held steady while striking the striking area on top of the driving rod handle with a hammer. The tool is of a size that can be easily stored in a workers tool box.

It is therefore an object of the invention to provide one tool that will work in all locations for the carpenter.

It is another object of the invention to provide one tool that can be hand or hammer driven.

It is another object of the invention to fit into tighter locations than other similar solutions.

It is another object of the invention to hold multiple sized nails.

It is another object of the invention to remain one assembled tool to prevent loss or inconvenience.

It is another object of the invention to reduce cost of operations through reduced tools.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side elevation view of a driver portion of the nail driver with the slide stop shown;

FIG. 2 is a top elevation view of a portion of the nail driver that holds the nail and provides a handle for the use to steady and secure the device;

FIG. 3 is a side and top elevations view of a nail drive driver portion inserted into the handle portion for moving the driver portion against the nail or for using a hammer to drive the driver portion against a nail; and

FIG. 4 is a side and top elevations view of an assembled nail driver showing all components in its assembled position.

For purposes of clarity and brevity, like elements and components will bear the same designations and numbering throughout the Figures.

### DESCRIPTION OF THE PREFERRED EMBODIMENT

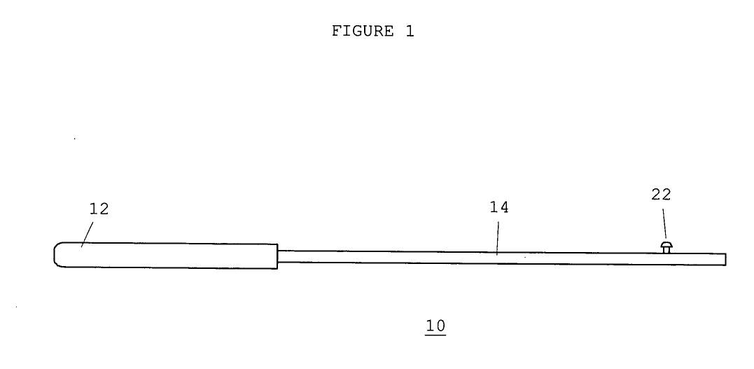

FIG. 1 is a side elevation view of a driver portion of the nail driver 10 with the slide stop 22 shown.

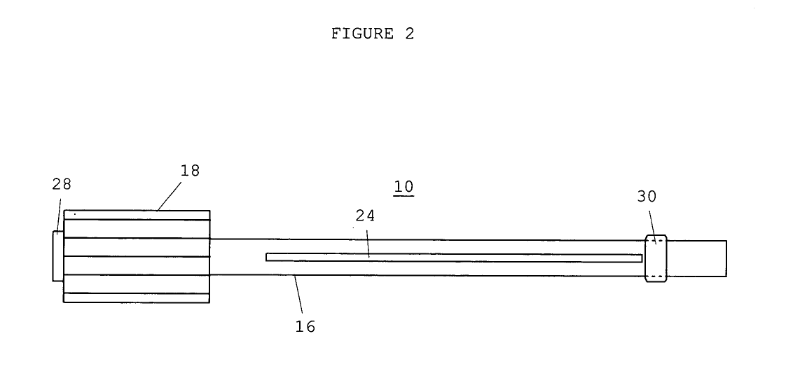

FIG. 2 is a top elevation view of a portion of the nail driver 10 that holds the nail and provides a handle for the use to steady and secure the device.

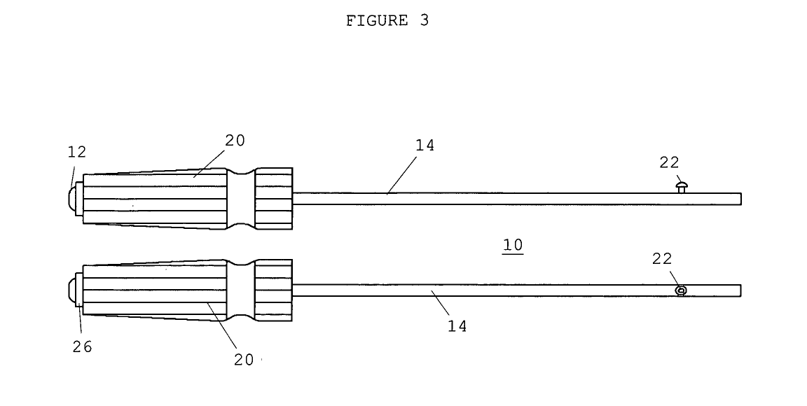

FIG. 3 is a side and top elevations view of a nail drive driver portion inserted into the handle portion for moving the driver portion against the nail or for using a hammer to drive the driver portion against a nail.

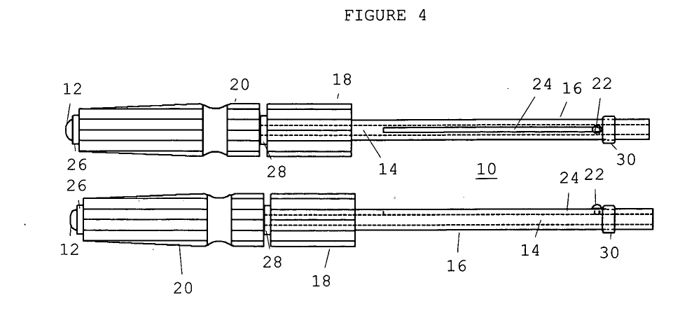

FIG. 4 is a side and top elevations view of an assembled nail driver 10 showing all components in its assembled position.

Referring to FIG. 1; a preferred embodiment of the driver portion of the nail driver 10. In the preferred embodiment there exists a long slender shaped hardened driving rod 14 with a permanently attached hammer head 12. The hammer head 12 end, being enlarged in diameter serving as a ram, over the driving rod 14 diameter and comprising a generally flattened end, to accompany a driving rod grip 20 (not shown) and provide a large generally flattened striking surface. The enlarged portion of the driving rod 14 in a preferred embodiment is weighted acting as a ram to help drive the nail (not shown) into its intended material. A driving rod 14 axially extends from the driving handle to transfer blows received from the hammer head 12 or the driving rod grip 20 to a nail located in the barrel 16 by means of a flattened end. The driving rod 14 is sufficient in length to reach the nail located in the barrel 16 and to permit the total penetration of said nail into a selected material for that purpose. A stop 22 right axially extended from the driving rod 14 driving rod 14 for retention within the barrel 16. The stop 22 in a preferred embodiment is small cylinder shaped embodiment with an enlarged end to prevent the barrel 16 from extending away from the driving rod 14. The stop 22 is sufficient in strength to facilitate the retention of the driving rod 14 into its barrel 16 through its movement up and down the barrel's channel 24.

Referring now to FIG. 2; depicts an axially extended barrel 16, having at one end a barrel grip shock absorber 28 sufficient in length to protect a users hand attached to the external portion of the barrel 16 and a hollow radial magnet 30 near the opposite end and in its preferred embodiment. This top view includes a hollow, elongated barrel 16 with magnet 30, which purpose is to magnetically hold a nail (not shown) internally to the barrel 16 for the driving rod 14 to strike, in a barrel 16 configuration with an inside diameter larger than the driving rod 14 so that the driving rod 14 (not shown) can slide with minimum friction. The barrel 16 can be a variety of diameters to accommodate a variety of nail head diameters (not shown). A channel 24, generally rectangular in shape and large enough in width to accommodate the stop 22 with minimal friction encompassing a majority of the length of one portion of the barrel 16 to permit the stop 22 to travel with long pounding strokes. In the preferred embodiment a barrel grip 18 is permanently bonded to the end of the barrel 16 away from the channel 24 end configured in such a manner to comfortably fit a user's hand. Its purpose is to hold the nail driver 10 (not shown) in position to insert the nail (not shown) into the proper location, and take up the shock of the contact from the nail driver 10 (not shown). At the end away from the channel 24 is permanently attached a shock absorber 26 of a flexible yet firm shock reducing material of sufficient size to protect the hand from receiving blows from the driving rod grip 20 (not shown) as the driver places the nail (not shown) in its deepest penetrating position and begins to contact the barrel grip 18. Below the channel 24 and before the barrel 16 end where the nail (not shown) is inserted, a generally donut shaped magnet 30 is sealably wrapped and affixed to the outside of the barrel 16 for the purpose of retaining an inserted nail (not shown) into the barrel 16 until it is forcibly driven by means of the driver (not shown) into its intended location. In the most preferred embodiment this magnet 30 would one such as a neodiaminironboride magnet 30 and would be secured with a strong resilient shrink wrap.

Referring now to FIG. 3; in the preferred embodiment of the current invention the assembled nail driver 10 is depicted. Starting at one end and working toward the other we see the hammer head 12 where a hammer would contact the present invention should a hammer be used to drive the nail (not shown) into its substrate. Next we see a shock absorber 26 permanently attached around the hammer head 12 and prior to the driving rod grip 20 to lesson impact if the hammer (not shown) should miss the hammer head 12 when being pounded. This is followed by the permanently attached driving rod grip 20 cylindrical shaped, ribbed and contoured in its preferred embodiment to lessen the possibility of the users hand slipping if the present invention is used without a hammer. In tight locations the sliding of the driving rod 14 against a nail head permits use in areas to tight to use a hammer (not shown) for pounding the hammer head 12. Following the driving rod 14 cylindrical in shape and hardened in its preferred embodiment the driving rod 14 makes contact with the nail head if being slid or pounded with a hammer forcing the nail into the material it is intended to enter. Lastly the stop 22 is encountered which acts as a retainer in the barrel 16 (not shown) preventing the barrel 16 from slipping off of the driver. This stop 22 consists of a cylindrical portion affixed with an extended diameter top portion larger than the channel 24 (not shown) located in the barrel 16 (not shown).

Referring now to FIG. 4; an assembled view of a preferred embodiment of the present invention there is provided a hammer head 12 with a generally flat striking surface for receiving blows from a pounding device such as a carpenters hammer (not shown). A shock absorber 26 permanently attached, generally tubular in shape, to reduce blow damage to the driving rod grip 20. A driving rod grip 20 configured to fit comfortably in a user's hand. A barrel grip shock absorber 28 generally tubular in shape, permanently attached to reduce shock and damage to the barrel grip 18 made of a flexible yet firm shock reducing material such as rubber, and of sufficient size to protect the hand from receiving blows from the driving rod grip 20 (not shown) when the nail is in its deepest most penetrating position. A barrel grip 18, permitting the user to hold in the nail driver 10 in place and guide the barrel 16 for positioning of the nail (not shown). A solid cylindrical driving rod 14 for contacting the nail (not shown) with the general purpose of causing the nail (not shown) to penetrate into a selected material (not shown). A barrel 16 for holding and guiding the driving rod 14 and the nail (not shown). A stop 22 inserted through the channel 24 of the barrel 16 into the driving rod 14 to prevent accidental disassembly of the present invention. In the preferred embodiment of this invention with the tool assembled as shown in FIG. 2 it shall be seen that the driving rod 14 and driving rod grip 20 are connected in such a manner as to facilitate the easy application of impacts to the nail (not shown) held in the barrel 16. That the barrel grip 18 and the driving rod grip 20 facilitate the ability to locate and insert nails(not shown) in to selected materials in tight hard to access locations as well as locations conventional insertion tools such as nail guns can access. Below the channel 24 and before the barrel 16 end where the nail (not shown) is inserted, a generally donut shaped magnet 30 is sealably wrapped and affixed to the outside of the barrel 16 for the purpose of retaining an inserted nail (not shown) into the barrel 16 until it is forcibly driven by means of the driver (not shown) into its intended location.

Provided is a description of the preferred embodiment of the present invention. It should be noted that other embodiments differing from the preferred embodiment described are possible and probable in certain circumstances for special use applications and that the described preferred embodiment should not be considered the only embodiment that the claims are intended to cover.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A nail driver for holding and driving nails into difficult to access locations, comprising:
means for holding and driving nails into tight locations that are generally not accessible by other more common nail driving techniques such as a hammer or nail gun. the nail driver permits the user to place nails accurately and effectively into tight inaccessible locations that are generally difficult to access;
means for serving as the contact point for a hammer when it strikes the driving rod and acting as dead weight useful for driving in a nail when a hammer is not employed;
means for delivering the force from the hammer head contact point either by hammer blows or hand initiated contacts using the driving rod grip to the nail head for the purpose of inserting the nail into the material at hand, integrally constructed to said means for serving as the contact point for a hammer when it strikes the driving rod and acting as dead weight useful for driving in a nail when a hammer is not employed;
means for serving as a guide to the driving rod and holder of the nail prior to and during the insertion of the nail into its intended material;
means for holding the nail driving tool in place while the user impacts the hammer head with a hammer or other pounding device or activates the driving rod by moving the driving rod grip in a manner that will apply substantial impacts to the driving rod to force the nail into the material at hand, insertably connected to said means for serving as a guide to the driving rod and holder of the nail prior to and during the insertion of the nail into its intended material;
means for applying impact blows to the nail held in the barrel through the repeated movement of the users hand or to provide a location to house the hammer head for impact blows generated by a hammer or other pounding device, insertably connected to said means for delivering the force from the hammer head contact point either by hammer blows or hand initiated contacts using the driving rod grip to the nail head for the purpose of inserting the nail into the material at hand, and rigidly connected to said means for serving as the contact point for a hammer when it strikes the driving rod and acting as dead weight useful for driving in a nail when a hammer is not employed;
means for preventing the driving rod from accidentally falling from the barrel, securely connected to said means for delivering the force from the hammer head contact point either by hammer blows or hand initiated contacts using the driving rod grip to the nail head for the purpose of inserting the nail into the material at hand;
means for providing a location for the stop to travel within so that the driving rod does not become disengaged from the barrel, integrally constructed to said means for serving as a guide to the driving rod and holder of the nail prior to and during the insertion of the nail into its intended material, and insertably assembled to said means for delivering the force from the hammer head contact point either by hammer blows or hand initiated contacts using the driving rod grip to the nail head for the purpose of inserting the nail into the material at hand;
means for reducing the impact of hammer or ram blows, rigidly connected to said means for applying impact blows to the nail held in the barrel through the repeated movement of the users hand or to provide a location to house the hammer head for impact blows generated by a hammer or other pounding device, and securely connected to said means for serving as the contact point for a hammer when it strikes the driving rod and acting as dead weight useful for driving in a nail when a hammer is not employed;
means for protecting the hand and barrel from impacts imparted by the ram or from a hammer such as a carpenters hammer, rigidly connected to said means for holding the nail driving tool in place while the user impacts the hammer head with a hammer or other pounding device or activates the driving rod by moving the driving rod grip in a manner that will apply substantial impacts to the driving rod to force the nail into the material at hand; and
means for holding a nail in place while the tool is positioned for insertion, sealably wrapped to said means for serving as a guide to the driving rod and holder of the nail prior to and during the insertion of the nail into its intended material.

2. The nail driver in accordance with claim 1, wherein said means for holding and driving nails into tight locations that are generally not accessible by other more common nail driving techniques such as a hammer or nail gun. The nail driver permits the user to place nails accurately and effectively into tight inaccessible locations that are generally difficult to access comprises a rigid, hard, holdable, slender, retractable, driveable, tubular nail driver.

3. The nail driver in accordance with claim 1, wherein said means for serving as the contact point for a hammer when it strikes the driving rod and acting as dead weight useful for driving in a nail when a hammer is not employed comprises a durable, generally flat, protruding, generally non malleable hammer head.

4. The nail driver in accordance with claim 1, wherein said means for delivering the force from the hammer head contact point either by hammer blows or hand initiated contacts using the driving rod grip to the nail head for the purpose of inserting the nail into the material at hand comprises a rigid, durable, cylindrical rod shaped, non malleable driving rod.

5. The nail driver in accordance with claim 1, wherein said means for serving as a guide to the driving rod and holder of the nail prior to and during the insertion of the nail into its intended material comprises a tubular, rigid, cylindrical barrel.

6. The nail driver in accordance with claim 1, wherein said means for holding the nail driving tool in place while the user impacts the hammer head with a hammer or other pounding device or activates the driving rod by moving the driving rod grip in a manner that will apply substantial impacts to the driving rod to force the nail into the material at hand comprises a generally tubular, gripable, rigid, durable, shock and vibration reducing barrel grip.

7. The nail driver in accordance with claim 1, wherein said means for applying impact blows to the nail held in the barrel through the repeated movement of the users hand or to provide a location to house the hammer head for impact blows generated by a hammer or other pounding device comprises a generally tubular, gripable, rigid, durable driving rod grip.

8. The nail driver in accordance with claim 1, wherein said means for preventing the driving rod from accidentally falling from the barrel comprises a mammilated, rigid, strong, durable stop.

9. The nail driver in accordance with claim 1, wherein said means for providing a location for the stop to travel within so that the driving rod does not become disengaged from the barrel comprises a channelized, generally rectangular channel.

10. The nail driver in accordance with claim 1, wherein said means for reducing the impact of hammer or ram blows comprises a generally tubular, impact reducing shock absorber.

11. The nail driver in accordance with claim 1, wherein said means for protecting the hand and barrel from impacts imparted by the ram or from a hammer such as a carpenters hammer comprises a generally tubular, impact reducing barrel grip shock absorber.

12. The nail driver in accordance with claim 1, wherein said means for holding a nail in place while the tool is positioned for insertion comprises a magnetic, donut shaped magnet.

13. A nail driver for holding and driving nails into difficult to access locations, comprising:
a rigid, hard, holdable, slender, retractable, driveable, tubular nail driver, for holding and driving nails into tight locations that are generally not accessible by other more common nail driving techniques such as a hammer or nail gun. the nail driver permits the user to place nails accurately and effectively into tight inaccessible locations that are generally difficult to access;
a durable, generally flat, protruding, generally non malleable hammer head, for serving as the contact point for a hammer when it strikes the driving rod and acting as dead weight useful for driving in a nail when a hammer is not employed;
a rigid, durable, cylindrical rod shaped, non malleable driving rod, for delivering the force from the hammer head contact point either by hammer blows or hand initiated contacts using the driving rod grip to the nail head for the purpose of inserting the nail into the material at hand, integrally constructed to said hammer head;
a tubular, rigid, cylindrical barrel, for serving as a guide to the driving rod and holder of the nail prior to and during the insertion of the nail into its intended material;
a generally tubular, gripable, rigid, durable, shock and vibration reducing barrel grip, for holding the nail driving tool in place while the user impacts the hammer head with a hammer or other pounding device or activates the driving rod by moving the driving rod grip in a manner that will apply substantial impacts to the driving rod to force the nail into the material at hand, insertably connected to said barrel;
a generally tubular, gripable, rigid, durable driving rod grip, for applying impact blows to the nail held in the barrel through the repeated movement of the users hand or to provide a location to house the hammer head for impact blows generated by a hammer or other pounding device, insertably connected to said driving rod, and rigidly connected to said hammer head;
a mammilated, rigid, strong, durable stop, for preventing the driving rod from accidentally falling from the barrel, securely connected to said driving rod;
a channelized, generally rectangular channel, for providing a location for the stop to travel within so that the driving rod does not become disengaged from the barrel, integrally constructed to said barrel, and insertably assembled to said driving rod;
a generally tubular, impact reducing shock absorber, for reducing the impact of hammer or ram blows, rigidly connected to said driving rod grip, and securely connected to said hammer head;
a generally tubular, impact reducing barrel grip shock absorber, for protecting the hand and barrel from impacts imparted by the ram or from a hammer such as a carpenters hammer, rigidly connected to said barrel grip; and
a magnetic, donut shaped magnet, for holding a nail in place while the tool is positioned for insertion, sealably wrapped to said barrel.

14. A nail driver for holding and driving nails into difficult to access locations, comprising:
a rigid, hard, holdable, slender, retractable, driveable, tubular nail driver, for holding and driving nails into tight locations that are generally not accessible by other more common nail driving techniques such as a hammer or nail gun. the nail driver permits the user to place nails accurately and effectively into tight inaccessible locations that are generally difficult to access;
a durable, generally flat, protruding, generally non malleable hammer head, for serving as the contact point for a hammer when it strikes the driving rod and acting as dead weight useful for driving in a nail when a hammer is not employed;
a rigid, durable, cylindrical rod shaped, non malleable driving rod, for delivering the force from the hammer head contact point either by hammer blows or hand initiated contacts using the driving rod grip to the nail head for the purpose of inserting the nail into the material at hand, integrally constructed to said hammer head;
a tubular, rigid, cylindrical barrel, for serving as a guide to the driving rod and holder of the nail prior to and during the insertion of the nail into its intended material;
a generally tubular, gripable, rigid, durable, shock and vibration reducing barrel grip, for holding the nail driving tool in place while the user impacts the hammer head with a hammer or other pounding device or activates the driving rod by moving the driving rod grip in a manner that will apply substantial impacts to the driving rod to force the nail into the material at hand, insertably connected to said barrel;
a generally tubular, gripable, rigid, durable driving rod grip, for applying impact blows to the nail held in the barrel through the repeated movement of the users hand or to provide a location to house the hammer head for impact blows generated by a hammer or other pounding device, insertably connected to said driving rod, and rigidly connected to said hammer head;
a mammilated, rigid, strong, durable stop, for preventing the driving rod from accidentally falling from the barrel, securely connected to said driving rod;
a channelized, generally rectangular channel, for providing a location for the stop to travel within so that the driving rod does not become disengaged from the barrel, integrally constructed to said barrel, and insertably assembled to said driving rod;
a generally tubular, impact reducing shock absorber, for reducing the impact of hammer or ram blows, rigidly connected to said driving rod grip, and securely connected to said hammer head;
a generally tubular, impact reducing barrel grip shock absorber, for protecting the hand and barrel from impacts imparted by the ram or from a hammer such as a carpenters hammer, rigidly connected to said barrel grip; and
a magnetic, donut shaped magnet, for holding a nail in place while the tool is positioned for insertion, sealably wrapped to said barrel.
